(19) United States
(12) Patent Application Publication
(10) Pub. No.: US 2024/0090531 A1
(43) Pub. Date: Mar. 21, 2024

(54) PLANT AND ANIMAL CELL BLENDED MEAT PRODUCTS AND METHODS OF PRODUCING THE SAME

(71) Applicant: Tender Food, Inc., Somerville, MA (US)

(72) Inventors: Luke MACQUEEN, Cambridge, MA (US); John Andrew GETSY, IV, Boston, MA (US); Elizabeth EISENACH, Boston, MA (US); Jade Elizabeth ZHU, Cambridge, MA (US); Richard COLWELL, Somerville, MA (US); Gemma COTTON, Allston, MA (US); Matthew SKINNER, Somerville, MA (US)

(21) Appl. No.: 18/352,348

(22) Filed: Jul. 14, 2023

Related U.S. Application Data
(60) Provisional application No. 63/407,472, filed on Sep. 16, 2022.

(51) Int. Cl. A23J 3/22

(52) U.S. Cl. CPC A23J 3/227

(57) ABSTRACT

Embodiments described herein relate to blended meat substitute products and methods of producing the same. In some aspects, a method of producing a meat substitute product can include providing a plant based scaffolding with a carrier material, the carrier material including animal cells, adding a gelation agent to at least one of the plant-based scaffolding, and incubating the carrier material and the plant-based scaffolding in a controlled environment to produce a meat substitute product. In some embodiments, the animal cells can include at least one of skeletal muscle cells, fat cells, connective tissue cells, or skin cells.

### CROSS-REFERENCE TO RELATED APPLICATIONS

This application claims priority to U.S. Provisional Application No. 63/407,472, filed Sep. 16, 2022 and titled “Plant and Animal Cell Blended Meat Products and Methods of Producing the Same,” the disclosure of which is hereby incorporated by reference in its entirety.

### STATEMENT REGARDING FEDERALLY SPONSORED RESEARCH

This invention was made with government support under 2112169 awarded by the National Science Foundation. The government has certain rights in the invention.

### TECHNICAL FIELD

Embodiments described herein relate to plant and animal cell-based meat products and methods of producing the same.

### BACKGROUND

Plant-based meats often have high nutritional value and minimal health drawbacks. For example, they can include any essential amino acids. However, they do not include the same proteins or fats found in animal tissues and often lack the sensory properties associated with meats derived from animals. Cell-based meats have recently emerged as a viable alternative to plant-based meats. Cell-based meats include animal cells that are cultured and used to construct muscle and/or fat tissues similar to those derived from animals. Scaleup of cell-based meats is difficult and includes many obstacles. Combining the positive aspects of plant-based meats and animal cell-based meats can result in a product with organoleptic properties similar to those of meats derived from live animals, producible at a competitive price point.

### SUMMARY

Embodiments described herein relate to blended meat substitute products and methods of producing the same. In some aspects, a method of producing a meat substitute product can include providing a plant based scaffolding with a carrier material, the carrier material including animal cells or compounds associated with animal flavor produced recombinantly, adding a gelation agent to at least one of the plant-based scaffolding or the carrier, and incubating the carrier material and the plant-based scaffolding in a controlled environment to produce a meat substitute product. In some embodiments, the animal cells can include at least one of skeletal muscle cells, fat cells, connective tissue cells, or skin cells. In some embodiments, the carrier can include a carrier liquid. In some embodiments, the carrier material can be a first carrier material, and the method can further include immersing the plant-based scaffold with a second carrier material, the second carrier material having a viscosity different from a viscosity of the first carrier material, the second carrier material having a penetration depth in the plant-based scaffold different from a penetration depth of the first carrier material. In some embodiments, the carrier material can be set within the scaffolding via a temperature treatment. In some embodiments, the carrier material can be set within scaffolds via ionic gelation. In some embodiments, cells can be cultured in the scaffolds. In some embodiments, the penetration depth of the carrier material into the scaffold can be controlled by modulating the moisture content of the scaffold.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Optional items in all figures shown in dashed lines.

FIG. 1 is a block diagram of a method of producing a plant and animal cell blended meat product, according to an embodiment.

FIG. 2 is a block diagram of a blended meat product, according to an embodiment.

FIGS. 3A-3C are illustrations of a process of producing a blended meat product, according to an embodiment.

FIGS. 4A-4D show soaking of scaffolds with various levels of carrier liquid diffusion.

FIGS. 5A-5C show detailed views of a plant-based meat substitute product with a transparent skin covering a scaffold.

FIGS. 6A-6B show scaffolds penetrated via soaking vs. injection.

FIG. 7 is an image of a plant-based meat substitute product.

### DETAILED DESCRIPTION

The field of tissue engineering includes biocompatible materials used as scaffolding for growth of biological cells and tissues. The cell types that form meats include muscle myofibers and fat adipocytes. Such cells are often anchorage-dependent, such that they rely on attachment substrates to survive and proliferate. For this reason, a variety of attachment substrates have been developed over the past several decades. These attachment substrates range from small spherical carriers used in suspension bioreactors to porous 3D matrices used in reaction beds. While tissue engineering applications are numerous, they are mostly limited to medical applications, with few aiming to produce edible products.

Applications for production of edible products are generally divided into two categories: (1) Traditional tissue engineering approaches, in which cells are cultured inside of scaffolds, or (2) blended products, in which cells multiply using various culture methods and are subsequently combined with a separate material that adds structure to the final products. Tissue engineering approaches often include long term culturing of cells (i.e., days to weeks, and sometimes multiple months), often in a material scaffold. This allows cell maturation and development into dense tissues. Such methods are often performed at small scales with tissue thickness limited to less than 0.5 mm because of diffusion limited nutrient transport. Efforts to vascularize tissues are in progress, but have yet to result in thick tissue production at scales or costs relevant to food production. Viable tissue engineering applications in the near term include those that focus on thin tissues, such as skin, cornea, or thin tissues that coat medical devices to improve implantation outcomes.

Blended product approaches have historically included expansion of cells and their subsequent addition to supporting materials. These methods are closer to price parity with meats derived from live animals, because the percentage of cells representing the final product is case dependent and can be low compared to most tissue engineering approaches. Cells are often harvested in a dense pellet and resuspended in scaffolds at a density that is dilute compared with the original cell pellet, animal meat tissue, or a tissue engineered product that has been cultured continuously. Allowing for significant cell proliferation during culture. Blended products make use of an edible base material to which cells can be included as an additive to improve nutrition, aroma, and/or flavor. Blended products are produced using various methods to retain cells within their supporting materials. However, when simply added as an aqueous solution to a supporting material, the distribution of cells within the material is difficult to control and the cells often simply flow through the material without being properly retained. Carrier liquids and gelation agents can aid in retaining cells in the supporting materials. Most natural tissues used in meats derived from living animals have distinct arrangements of multiple cell types that give rise to each meat's characteristic properties. Blended products can also suffer from cell immaturity because they are not given enough time to develop within a structural framework that directs their development along pathways that are seen in natural tissues. For this reason, long muscle fibers are unlikely in blended products of the current state of the art.

Fibrous plant-based scaffolds can replicate long muscle fiber morphology, both in terms of length and diameter. Accordingly, fibrous plant-based scaffolds can contribute to texture (organoleptic properties) that would otherwise be lacking if immature muscle cells are used. For this reason, blended products based on fibrous scaffolds can have a better texture than even 100% muscle tissues if the muscle tissues are immature compared to the muscle tissues in animals, as has heretofore been the case. 3D printing is another strategy used to impart “fibrous” texture, but suffers from a significant throughput limitation, because the material extrusion rate is inversely proportional to the extrusion diameter, and muscle fiber diameters range between 10 micrometers and 150 micrometers, making 3D printing slow and impractical at that scale even if multiple nozzles are used.

Methods described herein relate to the combination of cultured cells with plant-based meat products to produce blended products containing both plant components and animal cell components. Methods described herein facilitate transferring of cells into plant-based materials and retention of cells within plant-based materials. Additionally, the transfer of specific cell types to specific regions within plant-based materials can facilitate production of layered or stratified tissues. Products resulting from the methods described herein can range from being substantially plant-based with few animal cells therein to being primarily animal cell-based. In some embodiments, cells can multiply within a plant-based material. Embodiments described herein can result in price parity with meats derived from living animals.

Some embodiments described herein can include plant proteins and animal cells described in U.S. Provisional Patent Application No. 63/346,172 (“the '172 application”), filed May 26, 2022, titled “Plant-Based Shredded Meat Products, and Meat Products, and Methods of Producing the Same,” the disclosure of which is hereby incorporated by reference in its entirety.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of fibers, the set of fibers can be considered as one electrode with multiple portions, or the set of electrodes can be considered as multiple, distinct fibers. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method). The term “set,” in reference to a carrier material, can refer to the gelation or hardening of the carrier material marked by a sharp increase in viscosity or by solidification. Carrier solutions can be set within scaffolds by a change in temperature or by addition of a gelation agent.

As used herein, “plant” or “plant-based” can include any material used for food production that is not animal-based. In other words, “plant” or “plant-based” are not limited to organisms in the plantae kingdom. For example, “plant-based scaffolding” described herein should be understood to include fungal-derived products, such as mycelium or plant-like protists, such as seaweed or algae.

The term “progenitor cell” is used herein to refer to cells that have a cellular phenotype that is more primitive (e.g., is at an earlier step along a developmental pathway or progression than is a fully differentiated cell) and has a higher degree of potency relative to a cell which it can give rise to by differentiation. Often, progenitor cells also have significant or very high proliferative potential. Progenitor cells can give rise to multiple distinct differentiated cell types or to a single differentiated cell type, depending on the developmental pathway and on the environment in which the cells develop and differentiate.

The term “stem cell” as used herein, refers to an undifferentiated cell which is capable of proliferation and giving rise to more progenitor cells having the ability to generate a large number of mother cells that can in turn give rise to differentiated, or differentiable daughter cells that are either terminally differentiated or may mature and/or differentiate further. The daughter cells themselves can be induced to proliferate and produce progeny that subsequently differentiate into one or more mature cell types, while also retaining one or more cells with parental developmental potential. The term “stem cell” refers to a subset of progenitors that have the capacity or potential, under particular circumstances, to differentiate to a more specialized or differentiated phenotype, and which retains the capacity, under certain circumstances, to proliferate without substantially differentiating. In one embodiment, the term stem cell refers generally to a naturally occurring mother cell whose descendants (progeny) specialize, often in different directions, by differentiation, e.g., by acquiring completely individual characters, as occurs in progressive diversification of embryonic cells and tissues. Cellular differentiation is a complex process typically occurring through many cell divisions. A differentiated cell may derive from a multipotent cell which itself is derived from a multipotent cell, and so on. While each of these multipotent cells may be considered stem cells, the range of cell types each can give rise to may vary considerably. Some differentiated cells also have the capacity to give rise to cells of greater developmental potential. Such capacity may be natural or may be induced artificially upon treatment with various factors. In many biological instances, stem cells are also “multipotent” because they can produce progeny of more than one distinct cell type, but this is not required for “stem-ness.” Self-renewal is the other classical part of the stem cell definition. In theory, self-renewal can occur by either of two major mechanisms. Stem cells may divide asymmetrically, with one daughter retaining the stem state and the other daughter expressing some distinct other specific function and phenotype. Alternatively, some of the stem cells in a population can divide symmetrically into two stems, thus maintaining some stem cells in the population as a whole, while other cells in the population give rise to differentiated progeny only. Formally, it is possible that cells that begin as stem cells might proceed toward a differentiated phenotype, but then “reverse” and re-express the stem cell phenotype, a term often referred to as “dedifferentiation” or “reprogramming” or “retrodifferentiation.”

The term “embryonic stem cell” is used to refer to the pluripotent stem cells of the inner cell mass of the embryonic blastocyst (see U.S. Pat. Nos. 5,843,780, 6,200,806, the contents of which are incorporated herein by reference). Such cells can similarly be obtained from the inner cell mass of blastocysts derived from somatic cell nuclear transfer (see, for example, U.S. Pat. Nos. 5,945,577, 5,994,619, 6,235,970, which are incorporated herein by reference). The distinguishing characteristics of an embryonic stem cell define an embryonic stem cell phenotype. Accordingly, a cell has the phenotype of an embryonic stem cell if it possesses one or more of the unique characteristics of an embryonic stem cell such that that cell can be distinguished from other cells. Exemplary distinguishing embryonic stem cell characteristics include, without limitation, gene expression profile, proliferative capacity, differentiation capacity, karyotype, responsiveness to particular culture conditions, and the like.

The term “adult stem cell” or “ASC” is used to refer to any multipotent stem cell derived from non-embryonic tissue, including fetal, juvenile, and adult tissue. Stem cells have been isolated from a wide variety of adult tissues including blood, bone marrow, brain, olfactory epithelium, skin, pancreas, skeletal muscle, and cardiac muscle. Each of these stem cells can be characterized based on gene expression, factor responsiveness, and morphology in culture. Exemplary adult stem cells include neural stem cells, neural crest stem cells, mesenchymal stem cells, hematopoietic stem cells, and pancreatic stem cells.

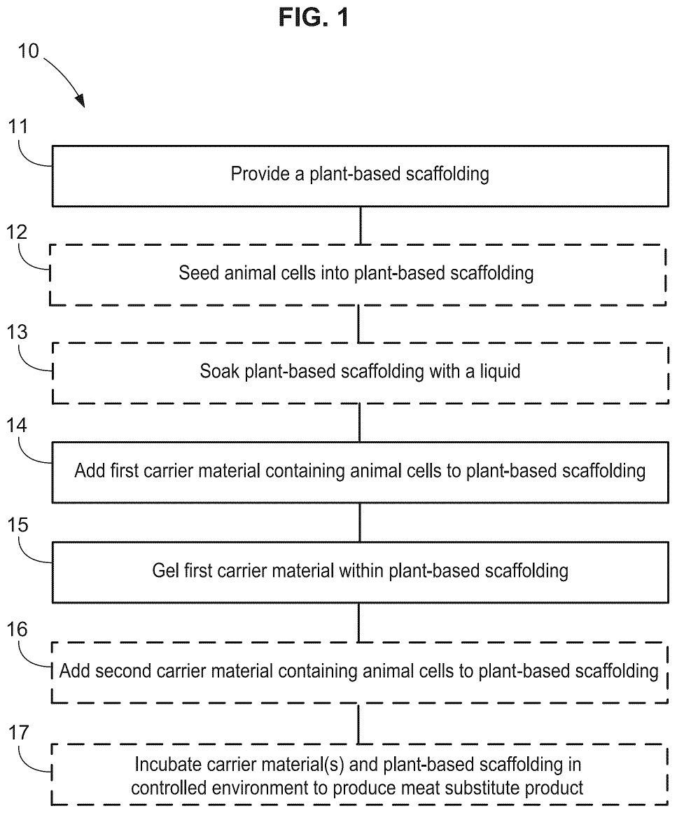

FIG. 1 is a block diagram of a method 10 of producing a plant and animal cell blended meat product, according to an embodiment. As shown, the method 10 includes providing a plant-based scaffolding at step 11. The method 10 optionally includes seeding animal cells into the plant-based scaffolding at step 12 and soaking the plant-based scaffolding with a liquid at step 13. The method 10 further includes adding a first carrier material containing animal cells to the plant-based scaffolding at step 14 and gelling the first carrier material within the plant-based scaffolding at step 15. The method 10 optionally includes adding a second carrier material containing animal cells to the plant-based scaffolding at step 16, the second carrier material containing animal cells. And incubating the carrier materials and the plant-based scaffolding in a controlled environment to produce a meat substitute product at step 17.

Step 11 includes provision of a plant-based scaffolding. In some embodiments, the plant-based scaffolding can include plant fibers. In some embodiments, the plant fibers can include bast fibers, leaf fibers, plant polysaccharides, starches, beta-glucans, cellulose, pectic polysaccharides, and/or seed-hair fibers. In some embodiments, the plant fibers can include fibers derived from flax, hemp, Indian hemp, jute, tossa jute, white jute, kenaf, ramie, roselle, sunn, urena, abaca, cantala, henequen, maguey, Mauritus hemp, phormium, sisal, akund floss, bagasse, bamboo, bombax cotton, coir, cotton, floss-silk trees, kapok, milkweed floss, or any combination thereof. In some embodiments, the plant-based scaffolding can include plant protein. In some embodiments, the plant protein can include proteins derived from rice, peas, soy, barley, barley rice, beans, fava beans, seitan, tempeh, edamame, lentils, chickpeas, nutritional yeast, spelt, teff, seeds, hemp seeds, amaranth, quinoa, spirulina, green peas, oats, Ezekiel bread, wild rice, nuts, chia seeds, mycoprotein, mycelium, or any combination thereof. In some embodiments, the plant protein can include one or more amino acids. In some embodiments, the plant protein can include alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, or any combination thereof. In some embodiments, the plant-based scaffolding can include an oil derived from plants. In some embodiments, the oil can be food safe. In some embodiments, the oil can be organic. In some embodiments, the oil can include coconut oil, canola oil, flaxseed oil, sunflower oil, soybean oil, corn oil, cottonseed oil, olive oil, palm oil, peanut oil, safflower oil, sesame oil, almond oil, beech nut oil, Brazil nut oil, cashew oil, hazelnut oil, macadamia oil, mongongo nut oil, pecan oil, pine nut oil, pistachio oil, walnut oil, pumpkin seed oil, or any combination thereof.

In some embodiments, the plant-based scaffolding can be grown or produced in a lab. In some embodiments, the plant-based scaffolding can be prefabricated (e.g., purchased from a vendor). In some embodiments, the plant-based scaffolding can be provided in its natural shape. In some embodiments, the plant-based scaffolding can be formed into a desired shape to facilitate diffusion of the carrier material into the plant-based scaffolding. In some embodiments, the plant-based scaffolding can be shaped via a mold. In some embodiments, the plant-based scaffolding can be 3D printed. In some embodiments, the plant-based scaffolding can have a tube shape, a substantially linear shape, a spherical shape, or any other suitable form factor or combinations thereof. Further examples of scaffolding form factors are described in U.S. Patent publication 2020/0330644 (“the '644 publication”), filed Oct. 16, 2018, titled, “Methods of Forming Three-Dimensional Tissues Scaffolds Using Biological Fiber Inks and Methods of Use Thereof” the disclosure of which is hereby incorporated by reference in its entirety.

Step 12 is optional and includes seeding animal cells into the plant-based scaffolding. In some embodiments, the animal cells can be seeded into a fibrous, fungal-derived product. In some embodiments, the fibrous, fungal-derived product can include mycelium. In some embodiments, the plant-based scaffolding can be prefabricated with animal cells therein. In some embodiments, step 12 can include loading the plant-based scaffold with muscle cells and blending with fat cells and covering with skin cells as desired. In some embodiments, step 12 can include delivering muscle and fat cells deep within the plant-based scaffolding. In some embodiments, the animal cells can be seeded into the plant-based scaffolding via injection. In some embodiments, the animal cells can be seeded into the plant-based scaffolding via soaking. In some embodiments, the carrier containing animal cells can be added to the top surface of a scaffold and allowed to soak and/or infiltrate the scaffold. In some embodiments, the animal cells can include skeletal muscle cells, fat cells, connective tissue cells, skin cells, or any combination thereof. In some embodiments, the animal cells can include mammalian cells, fish cells, avian muscle myoblasts, mammalian-derived myoblasts, avian-derived myoblasts, fish-derived myoblasts, myosatellites, fibroblasts, adipocytes, endothelial cells, epithelial cells, keratinocytes, stem cells, or any combination thereof. In some embodiments, each cell type can be combined with a specific carrier solution with properties tailored to deliver the cells to specific regions within the scaffolds.

Step 13 is optional and includes soaking the plant-based scaffolding with a liquid. In some embodiments, soaking the plant-based scaffolding can facilitate penetration of the carrier material (s) (e.g., carrier liquids) into the plant-based scaffolding. In some embodiments, soaking the plant-based scaffolding with a liquid can facilitate gelation of the carrier material. In some embodiments, the liquid used to soak the plant-based scaffolding can include salts that manipulate osmotic pressure in the plant-based scaffolding and open pores in the plant-based scaffolding. In some embodiments, the liquid used to soak the plant-based scaffolding can include a liquid that is free or substantially free of salts, such that the liquid manipulates the osmotic pressure in the plant-based scaffolding, drawing salt from the plant-based scaffolding. Drawing salt from the plant-based scaffolding can facilitate opening of the pores of the plant-based scaffolding. In some embodiments, the liquid used to soak the plant-based scaffolding can include water, ethanol, glycerol, or any combination thereof. In some embodiments, the liquid used to soak the plant-based scaffolding can aid in ionic gelation of polysaccharide carriers. In some embodiments, the liquid used to soak the plant-based scaffolding can include calcium lactate, calcium chloride, magnesium lactate, potassium-containing compounds (e.g., potassium chloride) and/or magnesium chloride. In some embodiments, the liquid used to soak the plant-based scaffolding can aid in thermal gelation. The hydration state of the plant-based scaffolding can be a factor in the ability of the plant-based scaffolding to absorb carrier materials and gelation agents. In some embodiments, the liquid used to soak the plant-based scaffolding can be kept at a temperature to induce gelation of the first carrier material. In some embodiments, the liquid used to soak the plant-based scaffolding can include hydrocolloids, methylcellulose, kappa carrageenan, iota carrageenan, or any combination thereof. In some embodiments, the liquid used to soak the plant-based scaffolding can be food safe. In some embodiments, step 13 can include draining the liquid used to soak the plant-based scaffolding.

In some embodiments, step 13 can result in the plant-based scaffolding having a moisture content (i.e., before the plant-based scaffolding is immersed with the carrier material) of at least about 35 wt %, at least about 40 wt %, at least about 45 wt %, at least about 50 wt %, at least about 55 wt %, at least about 60 wt %, at least about 65 wt %, at least about 70 wt %, at least about 75 wt %, at least about 80 wt %, at least about 85 wt %, or at least about 90 wt %. In some embodiments, step 13 can result in the plant-based scaffolding having a moisture content of no more than about 95 wt %, no more than about 90 wt %, no more than about 85 wt %, no more than about 80 wt %, no more than about 75 wt %, no more than about 70 wt %, no more than about 65 wt %, no more than about 60 wt %, no more than about 55 wt %, no more than about 50 wt %, no more than about 45 wt %, or no more than about 40 wt %. Combinations of the above-referenced water contents are also possible (e.g., at least about 35 wt % and no more than about 95 wt % or at least about 40 wt % and no more than about 90 wt %), inclusive of all values and ranges therebetween. In some embodiments, step 13 can result in the plant-based scaffolding having a moisture content of about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, or about 95 wt %.

Step 14 includes adding the first carrier material to the plant-based scaffolding. The first carrier material includes animal cells. In some embodiments, the first carrier material can include a carrier liquid. In some embodiments, the carrier liquid can be injected into the plant-based scaffolding. In some embodiments, the carrier liquid can be heated. In some embodiments, the carrier liquid can experience gelation upon heating. In some embodiments, the first carrier material can include a carrier gas. In some embodiments, the first carrier material can include a gel. In some embodiments, the animal cells can be mixed with the first carrier material prior to adding the first carrier material to the plant-based scaffolding. In some embodiments, the animal cells can include skeletal muscle cells, fat cells, connective tissue cells, skin cells, or any combination thereof. In some embodiments, the animal cells can include mammalian cells, fish cells, avian muscle myoblasts, fibroblasts, adipocytes, endothelial cells, epithelial cells, keratinocytes, stem cells, or any combination thereof. In some embodiments, the animal cells in the first carrier material can have a concentration of, at least about 50,000 cells/ml, at least about 100,000 cells/ml, at least about 500,000 cells/ml, at least about 1,000,000 cells/ml, at least about 5,000,000 cells/ml, at least about 10,000,000 cells/ml, or at least about 50,000,000 cells/ml. In some embodiments, the animal cells in the first carrier material can have a concentration of no more than about 100,000,000 cells/ml, no more than about 50,000,000 cells/ml, no more than about 10,000,000 cells/ml, no more than about 5,000,000 cells/ml, 1,000,000 cells/ml, no more than about 500,000 cells/ml, no more than about 100,000 cells/ml, or no more than about 50,000 cells/ml. Combinations of the above-referenced cell concentrations are also possible (e.g., at least about 50,000 cells/ml and no more than about 100,000,000 cells/ml or at least about 100,000 cells/ml and no more than about 1,000,000 cells/ml), inclusive of all values and ranges therebetween. In some embodiments, the animal cells in the first carrier material can have a concentration of about 50,000 cells/ml, about 100,000 cells/ml, about 500,000 cells/ml, about 1,000,000 cells/ml, about 5,000,000 cells/ml, about 10,000,000 cells/ml, about 50,000,000 cells/ml, or about 100,000,000 cells/ml.

In some embodiments, the first carrier material can be water-based, alcohol-based, or oil-based. The carrier material can determine how far the animal cells penetrate into the scaffold. In some embodiments, the first carrier material can undergo ionic gelation. In some embodiments, the first carrier material can include polysaccharides, such as pectin, chitosan, alginate, or any combination thereof. Dilute solutions of a carrier liquid undergoing ionic gelation can be used for deep infiltration of muscle cells into the plant-based scaffolding, while concentrated solutions can be used to create a skin. In some embodiments, the first carrier material can include agar, pectin, alginate, carrageenan, gellan, gelatin, modified starch, methyl cellulose, hydroxypropylmethyl cellulose, or any combination thereof. In some embodiments, the first carrier material can include a polysaccharide dissolved in water. In some embodiments, the amount of polysaccharide dissolved in the water can be dependent on the desired viscosity of the first carrier material.

In some embodiments, the first carrier material can undergo thermal gelation. In some embodiments, the first carrier material can include starch, modified starch, methyl cellulose, polysaccharides, and/or plant proteins. In some embodiments, starch can be added to the scaffolding before adding methyl cellulose. In some embodiments, curdlan and/or konjac glucomannan can be added to the scaffolding as heat setting polymers. In some embodiments, the first carrier material can be water-based. In some embodiments, the first carrier material can be edible. In some embodiments, the first carrier material can be food safe. In some embodiments, the first carrier material can be mixed with a fat substitute. In some embodiments, the first carrier material can include water and ethanol. In some embodiments, the first carrier material can include water with monovalent ions, divalent ions, salts of monovalent ions, salts of divalent ions, or any combination thereof. In some embodiments, the monovalent ions and/or divalent ions can be cations, anions, or mixtures thereof. In some embodiments, the salts can include protons (or hydronium ions) or hydroxide ions that modulate pH. In some embodiments, the first carrier material can be formulated to deliver cells to predefined regions in the plant-based scaffolding and in an area surrounding the plant-based scaffolding. The carrier material can be formulated to retain the cells and prevent the cells from leaking out of the product. In some embodiments, the first carrier material can be formulated such that any fat included in the first material melts out, causing the product to sizzle when cooked.

In some embodiments, the first carrier material can be organic (i.e., relating to or derived from living matter). In some embodiments, the first carrier material can be certified organic, as defined by the United States Department of Agriculture (USDA). In some embodiments, the first carrier material can be composed of ingredients produced via processes overseen by the USDA's National Organic Program (NOP), and/or a certifying agent thereof. In some embodiments, the ingredients of the first carrier material can be produced following USDA regulations in certifying the organic character of the ingredients. In some embodiments, the components of the first carrier material can be produced using “allowed substances” for organic certification, as designated by the USDA in 7 U.S.C. § 205(g). In some embodiments, the first carrier material can include ingredients that are 100 wt % organic, excluding salt and water, as defined by the USDA (i.e., the ingredients can meet the criteria for USDA's “100% organic” label). In some embodiments, the first carrier material can include ingredients that are at least 95 wt % organic, excluding salt and water, as defined by the USDA (i.e., the ingredients can meet the criteria for USDA's “organic” label). In some embodiments, the first carrier material can include ingredients that are at least 70 wt % organic, excluding salt and water, as defined by the USDA (i.e., the ingredients can meet the criteria for USDA's “Made with Organic ______” label).

In some embodiments, the first carrier material can have a specific penetration depth into the plant-based scaffolding. In some embodiments, the penetration depth of the first carrier material can be related to the viscosity of the first carrier material. In some embodiments, the viscosity of the first carrier material can be inversely proportional to the penetration depth of the first carrier material. In other words, the viscosity of the first carrier material can be controlled (e.g., via addition of a specified amount of the gelation agent) to control the penetration depth of the first carrier material. In some embodiments, the animal cell type can be matched to a specific carrier liquid (e.g., muscle cells in a dilute carrier liquid that infiltrate the bulk scaffold volume, followed by skin cells in a thick carrier liquid that coats the surface of the plant-based scaffolding). The penetration depth of the first carrier liquid can be a reliable metric to measure the diffusion of samples added to the surface of the plant-based scaffolding. In some embodiments, the first carrier material can be added to the plant-based scaffolding via soaking and/or immersing the plant-based scaffolding in the first carrier material. In some embodiments, the first carrier material can be added to the plant-based scaffolding via injecting the first carrier material into the plant-based scaffolding. In some embodiments, the first carrier material and/or the second carrier material can set thermally. In some embodiments, the first carrier material and/or the second carrier material can be gelled by exposure to a temperature differential. In some embodiments, the first carrier material and/or the second carrier material can gel when exposed to temperatures higher than the mixing temperature. For example, temperatures ranging between about 50° C. and about 120° C. can be used to gel various starches.

In some embodiments, the first carrier material and/or the second carrier material can be heated to a temperature of at least about 30° C., at least about 40° C., at least about 50° C., at least about 60° C., at least about 70° C., at least about 80° C., at least about 90° C., at least about 100° C., at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., at least about 220° C., at least about 230° C., at least about 240° C., at least about 250° C., at least about 260° C., at least about 270° C., at least about 280° C., or at least about 290° C. In some embodiments, the first carrier material and/or the second carrier material can be heated to a temperature of no more than about 300° C., no more than about 290° C., no more than about 280° C., no more than about 270° C., no more than about 260° C., no more than about 250° C., no more than about 240° C., no more than about 230° C., no more than about 220° C., no more than about 210° C., no more than about 200° C., no more than about 190° C., no more than about 180° C., no more than about 170° C., no more than about 160° C., no more than about 150° C., no more than about 140° C., no more than about 130° C., no more than about 120° C., no more than about 110° C., no more than about 100° C., no more than about 90° C., no more than about 80° C., no more than about 70° C., no more than about 60° C., no more than about 50° C., or no more than about 40° C. Combinations of the above-referenced temperatures are also possible (e.g., at least about 30° C. and no more than about 300° C. or at least about 50° C. and no more than about 140° C.), inclusive of all values and ranges therebetween. In some embodiments, the first carrier material and/or the second carrier material can be heated to a temperature of about 30° C., about 40° C., about 50° C., about 60° C., about 70° C., about 80° C., about 90° C., about 100° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., or about 300° C.

In some embodiments, the first carrier material can be injected and then induced to gel by using heat. In some embodiments, the scaffolding can be compressed and/or massaged before heating to improve the evenness of the distribution of the hydrogel that results from heating the carrier solution. In some embodiments, the scaffolding can be compressed during heating. In some embodiments, the first carrier material and/or the second carrier material can be injected and distributed evenly through the scaffolding. In some embodiments, the first carrier material and/or the second carrier material can be injected into localized areas of the scaffolding.

In some embodiments, the animal cells can attach to the scaffolding via an attachment substrate. In other words, the animal cells can be cultured in conditions that promote cell attachment. An attachment substrate can substantially reduce the amount of time needed for the animal cells to attach to the scaffolding. In some embodiments, the attachment substrates can include small spherical carriers used in suspension bioreactors (e.g., spherical carriers with a particle size of about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, or about 100 μm, inclusive of all values and ranges therebetween) and/or porous 3D matrices used in reaction beds. In some embodiments, the attachment substrates can be composed of hydrogels. In some embodiments, the attachment substrates can be composed of the same material as the plant-based scaffolding (e.g., combinations of polysaccharides and plant proteins).

Step 15 includes gelling the first carrier material within the plant-based scaffolding. In some embodiments, the gelling can be via a gelation agent. In some embodiments, the gelation can be via ionic gelation. In some embodiments, the gelation can be via thermal treatment. In some embodiments, the gelation agent can be added via injection into the plant-based scaffolding. When injecting the gelation agent, the diffusion distance from the addition point of the percent coverage of the inside of the sample is measured. In some embodiments, the gelation agent can be mixed with the first carrier material before immersing the plant-based scaffolding in the first carrier material. In some embodiments, the gelation agent can be mixed with the first carrier material after immersing the plant-based scaffolding in the first carrier material. In some embodiments, the gelation agent can be plant-based. In some embodiments, the gelation agent can include hydrocolloids, methylcellulose, high viscosity methylcellulose, methylcellulose E/F/K, kappa carrageenan, iota carrageenan, or any combination thereof. In some embodiments, the gelation agent can induce ionic gelation in the first carrier material. In some embodiments, the first carrier material can undergo gelation via ion exchange. In some embodiments, the first carrier material can undergo gelation via sodium-calcium exchange.

In some embodiments, the gelling can be via a temperature treatment (e.g., a heat treatment). In some embodiments, the first carrier material within the plant-based scaffolding can be temperature treated to a temperature of at least about 60° C., at least about 65° C., at least about 70° C., at least about 75° C., at least about 80° C., at least about 85° C., at least about 90° C., at least about 95° C., at least about 100° C., at least about 105° C., at least about 110° C., or at least about 115° C. In some embodiments, the first carrier material within the plant-based scaffolding can be temperature treated to a temperature of no more than about 120° C., no more than about 115° C., no more than about 110° C., no more than about 105° C., no more than about 100° C., no more than about 95° C., no more than about 90° C., no more than about 85° C., no more than about 80° C., no more than about 75° C., no more than about 70° C., or no more than about 65° C. Combinations of the above-referenced temperatures are also possible (e.g., at least about 60° C. and no more than about 120° C. or at least about 80° C. and no more than about 100° C.), inclusive of all values and ranges therebetween. In some embodiments, the first carrier material within the plant-based scaffolding can be temperature treated to a temperature of about 60° C., about 65° C., about 70° C., about 75° C., about 80° C., about 85° C., about 90° C., about 95° C., about 100° C., about 105° C., about 110° C., about 115° C., or about 120° C. In some embodiments, the gelling can be via a steam treatment.

In some embodiments, the gelation agent can soak the plant-based scaffolding prior to the addition of the carrier material with the animal cells (i.e., prior to step 14). In other words, the plant-based scaffolding can be pre-soaked with a gelation agent. The pre-soaking can be done such that the first carrier material gels upon contacting the gelation agent present in the scaffold. For example, pre-soaking the plant-based scaffolding with calcium lactate or calcium chloride will cause pectin-based carriers to gel when they are added to the plant-based scaffolding. For such a gelation to occur, the pre-soaked gelation agent concentration should be relatively low (i.e., less than about 5 wt %, less than about 4 wt %, less than about 3 wt %, less than about 2 wt %, or less than about 1 wt % of the weight of the plant-based scaffolding) to allow infiltration into the first carrier material without premature gelation. In some embodiments, the gelation agent can be added to the plant-based scaffolding both before and after the addition of the first carrier material and the animal cells to the plant-based scaffolding. In some embodiments, a first gelation agent can be added to the plant-based scaffolding before the addition of the first carrier material and a second gelation agent can be added to the plant-based scaffolding after the addition of the first carrier material.

In some embodiments, the plant-based scaffolding is not pre-soaked in a gelation agent. In such embodiments, the first carrier material and the animal cells are added to the plant-based scaffolding and the plant-based scaffolding (with the first carrier material and the animal cells) is immersed into the gelation agent. In such a case, the gelation agent is at a higher concentration (i.e., at least about 5 wt %, at least about 6 wt %, at least about 7 wt %, at least about 8 wt %, at least about 9 wt %, or at least about 10 wt % of the weight of the plant-based scaffolding) than in a pre-soaked case in order to induce instant or fast gelation, such that the first carrier material and the animal cells are restrained in place before they are able to be washed away.

In some embodiments, the gelation agent can be added stepwise after each combination of carrier liquid and animal cell combination. For example, a dilute carrier liquid with muscle cells can be added to the plant-based scaffolding and then gelled by adding the gelation agent. Then, a thick carrier liquid with animal cells (skin) can be added as a scaffold coating and the full product is then further gelled.

In some embodiments, the gelation agent can have a concentration in the first carrier material of at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 2 wt %, at least about 3 wt %, at least about 4 wt %, at least about 5 wt %, at least about 6 wt %, at least about 7 wt %, at least about 8 wt %, or at least about 9 wt %. In some embodiments, the gelation agent can have a concentration in the first carrier material of no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, or no more than about 0.2 wt %. Combinations of the above-referenced concentrations of the gelation agent in the first carrier material are also possible (e.g., at least about 0.1 wt % and no more than about 10 wt % or at least about 0.5 wt % and no more than about 8 wt %), inclusive of all values and ranges therebetween. In some embodiments, the gelation agent can have a concentration in the first carrier material of about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, or about 10 wt %.

In some embodiments, prior to addition of the gelation agent, the first carrier material can have a viscosity of at least about 1 mPa·s, at least about 2 mPa·s, at least about 3 mPa·s, at least about 4 mPa·s, at least about 5 mPa·s, at least about 6 mPa·s, at least about 7 mPa·s, at least about 8 mPa·s, at least about 9 mPa·s, at least about 10 mPa·s, at least about 20 mPa·s, at least about 30 mPa·s, at least about 40 mPa·s, at least about 50 mPa·s, at least about 60 mPa·s, at least about 70 mPa·s, at least about 80 mPa·s, at least about 90 mPa·s, at least about 100 mPa·s, at least about 200 mPa·s, at least about 300 mPa·s, at least about 400 mPa·s, at least about 500 mPa·s, at least about 600 mPa·s, at least about 700 mPa·s, at least about 800 mPa·s, at least about 900 mPa·s, at least about 1,000 mPa·s, at least about 2,000 mPa·s, at least about 3,000 mPa·s, at least about 4,000 mPa·s, at least about 5,000 mPa·s, at least about 6,000 mPa·s, at least about 7,000 mPa·s, at least about 8,000 mPa·s, or at least about 9,000 mPa·s. In some embodiments, prior to addition of the gelation agent, the first carrier material can have a viscosity of no more than about 10,000 mPa·s, no more than about 9,000 mPa·s, no more than about 8,000 mPa·s, no more than about 7,000 mPa·s, no more than about 6,000 mPa·s, no more than about 5,000 mPa·s, no more than about 4,000 mPa·s, no more than about 3,000 mPa·s, no more than about 2,000 mPa·s, no more than about 1,000 mPa·s, no more than about 900 mPa·s, no more than about 800 mPa·s, no more than about 700 mPa·s, no more than about 600 mPa·s, no more than about 500 mPa·s, no more than about 400 mPa·s, no more than about 300 mPa·s, no more than about 200 mPa·s, no more than about 100 mPa·s, no more than about 90 mPa·s, no more than about 80 mPa·s, no more than about 70 mPa·s, no more than about 60 mPa·s, no more than about 50 mPa·s, no more than about 40 mPa·s, no more than about 30 mPa·s, no more than about 20 mPa·s, no more than about 10 mPa·s, no more than about 9 mPa·s, no more than about 8 mPa·s, no more than about 7 mPa·s, no more than about 6 mPa·s, no more than about 5 mPa·s, no more than about 4 mPa·s, no more than about 3 mPa·s, or no more than about 2 mPa·s. Combinations of the above-referenced viscosities are also possible (e.g., at least about 1 mPa·s and no more than about 10,000 mPa·s or at least about 100 mPa·s and no more than about 1,000 mPa·s), inclusive of all values and ranges therebetween. In some embodiments, prior to addition of the gelation agent, the first carrier material can have a viscosity of about 1 mPa·s, about 2 mPa·s, about 3 mPa·s, about 4 mPa·s, about 5 mPa·s, about 6 mPa·s, about 7 mPa·s, about 8 mPa·s, about 9 mPa·s, about 10 mPa·s, about 20 mPa·s, about 30 mPa·s, about 40 mPa·s, about 50 mPa·s, about 60 mPa·s, about 70 mPa·s, about 80 mPa·s, about 90 mPa·s, about 100 mPa·s, about 200 mPa·s, about 300 mPa·s, about 400 mPa·s, about 500 mPa·s, about 600 mPa·s, about 700 mPa·s, about 800 mPa·s, about 900 mPa·s, about 1,000 mPa·s, about 2,000 mPa·s, about 3,000 mPa·s, about 4,000 mPa·s, about 5,000 mPa·s, about 6,000 mPa·s, about 7,000 mPa·s, about 8,000 mPa·s, about 9,000 mPa·s, or about 10,000 mPa·s.

The viscosity of the first carrier material can be a function of the desired penetration depth into the plant-based scaffolding. For example, the amount of polysaccharide added to water affects the resulting viscosity. After addition of the gelation agent, the first carrier material becomes a carrier gel. The first carrier material can be exposed to the gelation agent (e.g., divalent salts diluted in water), and the first carrier material solidifies with a rate of solidification depending on the concentration of the first carrier material and the gelation agent. In some embodiments, the gelation can be rapid, such that the first carrier material can be considered solid after exposure to the gelation agent, thereby holding the carrier gel in place. In some embodiments, the dynamics of gel setting can be advantageous in the context of determining the extent of penetration of the first carrier material into the plant-based scaffolding prior to complete gelation.

In some embodiments, after addition of the gelation agent, carrier gel can have a viscosity of at least about 10 mPa·s, at least about 20 mPa·s, at least about 30 mPa·s, at least about 40 mPa·s, at least about 50 mPa·s, at least about 60 mPa·s, at least about 70 mPa·s, at least about 80 mPa·s, at least about 90 mPa·s, at least about 100 mPa·s, at least about 200 mPa·s, at least about 300 mPa·s, at least about 400 mPa·s, at least about 500 mPa·s, at least about 600 mPa·s, at least about 700 mPa·s, at least about 800 mPa·s, at least about 900 mPa·s, at least about 1,000 mPa·s, at least about 2,000 mPa·s, at least about 3,000 mPa·s, at least about 4,000 mPa·s, at least about 5,000 mPa·s, at least about 6,000 mPa·s, at least about 7,000 mPa·s, at least about 8,000 mPa·s, at least about 9,000 mPa·s, at least about 10,000 mPa·s, at least about 20,000 mPa·s, at least about 30,000 mPa·s, at least about 40,000 mPa·s, at least about 50,000 mPa·s, at least about 60,000 mPa·s, at least about 70,000 mPa·s, at least about 80,000 mPa·s, or at least about 90,000 mPa·s. In some embodiments, after addition of the gelation agent, the carrier gel can have a viscosity of no more than about 100,000 mPa·s, no more than about 90,000 mPa·s, no more than about 80,000 mPa·s, no more than about 70,000 mPa·s, no more than about 60,000 mPa·s, no more than about 50,000 mPa·s, no more than about 40,000 mPa·s, no more than about 30,000 mPa·s, no more than about 20,000 mPa·s, no more than about 10,000 mPa·s, no more than about 9,000 mPa·s, no more than about 8,000 mPa·s, no more than about 7,000 mPa·s, no more than about 6,000 mPa·s, no more than about 5,000 mPa·s, no more than about 4,000 mPa·s, no more than about 3,000 mPa·s, no more than about 2,000 mPa·s, no more than about 1,000 mPa·s, no more than about 900 mPa·s, no more than about 800 mPa·s, no more than about 700 mPa·s, no more than about 600 mPa·s, no more than about 500 mPa·s, no more than about 400 mPa·s, no more than about 300 mPa·s, no more than about 200 mPa·s, no more than about 100 mPa·s, no more than about 90 mPa·s, no more than about 80 mPa·s, no more than about 70 mPa·s, no more than about 60 mPa·s, no more than about 50 mPa·s, no more than about 40 mPa·s, no more than about 30 mPa·s, or no more than about 20 mPa·s. Combinations of the above-referenced viscosities are also possible (e.g., at least about 10 mPa·s and no more than about 100,000 mPa·s or at least about 1,000 mPa·s and no more than about 10,000 mPa·s), inclusive of all values and ranges therebetween. In some embodiments, after addition of the gelation agent, the carrier gel can have a viscosity of about 10 mPa·s, about 20 mPa·s, about 30 mPa·s, about 40 mPa·s, about 50 mPa·s, about 60 mPa·s, about 70 mPa·s, about 80 mPa·s, about 90 mPa·s, about 100 mPa·s, about 200 mPa·s, about 300 mPa·s, about 400 mPa·s, about 500 mPa·s, about 600 mPa·s, about 700 mPa·s, about 800 mPa·s, about 900 mPa·s, about 1,000 mPa·s, about 2,000 mPa·s, about 3,000 mPa·s, about 4,000 mPa·s, about 5,000 mPa·s, about 6,000 mPa·s, about 7,000 mPa·s, about 8,000 mPa·s, about 9,000 mPa·s, about 10,000 mPa·s, about 20,000 mPa·s, about 30,000 mPa·s, about 40,000 mPa·s, about 50,000 mPa·s, about 60,000 mPa·s, about 70,000 mPa·s, about 80,000 mPa·s, about 90,000 mPa·s, or about 100,000 mPa·s.

Step 16 is optional and includes adding a second carrier material to the plant-based scaffolding. In some embodiments, the second carrier material can include a carrier liquid. In some embodiments, the second carrier material can include a carrier gas. In some embodiments, the second carrier material can include a gel. The second carrier material can include animal cells. In some embodiments, the animal cells can be mixed with the second carrier material prior to adding the second carrier material to the plant-based scaffolding. In some embodiments, the second carrier material can be substantially different from the first carrier material. For example, the first carrier material can be water-based and the second carrier material can be oil-based. In some embodiments, the second carrier material can be immiscible with the first carrier material. In some embodiments, the second carrier material can be used to create an outer layer or a “skin” of the final product. In some embodiments, the second carrier material can include fats and/or oils. In some embodiments, the second carrier material can have any of the properties described above with reference to the first carrier material (e.g., “certified organic”). In some embodiments, the second carrier material can include a gelation agent. In some embodiments, the gelation agent included in the second carrier material can be the same as the gelation agent included in the first carrier material. In some embodiments, the first carrier material can include a first gelation agent and the second carrier material can include a second gelation agent, the second gelation agent different from the first gelation agent. In some embodiments, the second carrier material can include methylcellulose, microcrystalline cellulose, kappa carrageenan, iota carrageenan, plant proteins, agar, pectin, alginate, carrageenan, xanthan gum, gelatin, modified starch, methyl cellulose, hydroxypropylmethyl cellulose, gellan gum, curdlan, nanoparticles, konjac glucomannan, or any combination thereof. In some embodiments, the second carrier material and the cells disposed therein can be designed to mimic fat. In some embodiments, the second carrier material can be added to the plant-based scaffolding via soaking and/or immersing the plant-based scaffolding in the first carrier material. In some embodiments, the first carrier material can be added to the plant-based scaffolding via injecting the first carrier material into the plant-based scaffolding.

In some embodiments, the second carrier material can have a viscosity greater than a viscosity of the first carrier material. In some embodiments, the second carrier material can have a viscosity of at least about 5 mPa·s, at least about 6 mPa·s, at least about 7 mPa·s, at least about 8 mPa·s, at least about 9 mPa·s, at least about 10 mPa·s, at least about 20 mPa·s, at least about 30 mPa·s, at least about 40 mPa·s, at least about 50 mPa·s, at least about 60 mPa·s, at least about 70 mPa·s, at least about 80 mPa·s, at least about 90 mPa·s, at least about 100 mPa·s, at least about 200 mPa·s, at least about 300 mPa·s, at least about 400 mPa·s, at least about 500 mPa·s, at least about 600 mPa·s, at least about 700 mPa·s, at least about 800 mPa·s, at least about 900 mPa·s, at least about 1,000 mPa·s, at least about 2,000 mPa·s, at least about 3,000 mPa·s, at least about 4,000 mPa·s, at least about 5,000 mPa·s, at least about 6,000 mPa·s, at least about 7,000 mPa·s, at least about 8,000 mPa·s, at least about 9,000 mPa·s, at least about 10,000 mPa·s, at least about 20,000 mPa·s, at least about 30,000 mPa·s, or at least about 40,000 mPa·s. In some embodiments, the second carrier material can have a viscosity of no more than about 50,000 mPa·s, no more than about 40,000 mPa·s, no more than about 30,000 mPa·s, no more than about 20,000 mPa·s, no more than about 10,000 mPa·s, no more than about 9,000 mPa·s, no more than about 8,000 mPa·s, no more than about 7,000 mPa·s, no more than about 6,000 mPa·s, no more than about 5,000 mPa·s, no more than about 4,000 mPa·s, no more than about 3,000 mPa·s, no more than about 2,000 mPa·s, no more than about 1,000 mPa·s, no more than about 900 mPa·s, no more than about 800 mPa·s, no more than about 700 mPa·s, no more than about 600 mPa·s, no more than about 500 mPa·s, no more than about 400 mPa·s, no more than about 300 mPa·s, no more than about 200 mPa·s, no more than about 100 mPa·s, no more than about 90 mPa·s, no more than about 80 mPa·s, no more than about 70 mPa·s, no more than about 60 mPa·s, no more than about 50 mPa·s, no more than about 40 mPa·s, no more than about 30 mPa·s, no more than about 20 mPa·s, no more than about 10 mPa·s, no more than about 9 mPa·s, no more than about 8 mPa·s, no more than about 7 mPa·s, or no more than about 6 mPa·s. Combinations of the above-referenced viscosities are also possible (e.g., at least about 5 mPa·s and no more than about 50,000 mPa·s or at least about 100 mPa·s and no more than about 10,000 mPa·s), inclusive of all values and ranges therebetween. In some embodiments, after addition of the gelation agent, the first carrier material can have a viscosity of about 5 mPa·s, about 6 mPa·s, about 7 mPa·s, about 8 mPa·s, about 9 mPa·s, about 10 mPa·s, about 20 mPa·s, about 30 mPa·s, about 40 mPa·s, about 50 mPa·s, about 60 mPa·s, about 70 mPa·s, about 80 mPa·s, about 90 mPa·s, about 100 mPa·s, about 200 mPa·s, about 300 mPa·s, about 400 mPa·s, about 500 mPa·s, about 600 mPa·s, about 700 mPa·s, about 800 mPa·s, about 900 mPa·s, about 1,000 mPa·s, about 2,000 mPa·s, about 3,000 mPa·s, about 4,000 mPa·s, about 5,000 mPa·s, about 6,000 mPa·s, about 7,000 mPa·s, about 8,000 mPa·s, about 9,000 mPa·s, about 10,000 mPa·s, about 20,000 mPa·s, about 30,000 mPa·s, about 40,000 mPa·s, or about 50,000 mPa·s.

In some embodiments, the first carrier material and the second carrier material can have differing material compositions. In some embodiments, the first carrier material can be a water-based carrier liquid while the second carrier material can be oil/fat based. In some embodiments, the first carrier material can be oil/fat based, while the second carrier material can be water based. In some embodiments, the first carrier material and the second carrier material can have similar material compositions, but in different concentrations. In some embodiments, the first carrier material can include water with a first polysaccharide concentration, while the second carrier material can include water with a second polysaccharide concentration, the second polysaccharide composition greater than the first polysaccharide composition. Varying concentrations yield varying viscosities and scaffold penetration dynamics. In some embodiments, the method 10 can include immersing the plant-based scaffolding with a third carrier material, a fourth carrier material, a fifth carrier material, a sixth carrier material, a seventh carrier material, an eighth carrier material, a ninth carrier material, or a tenth carrier material. Any combination of the aforementioned carrier materials is also possible. For example, the plant-based scaffolding can be immersed in one fat/oil-based carrier and two different pectin-based carriers. In some embodiments, the first carrier material can be delivered via a first method and the second carrier material can be delivered via a second method. In some embodiments, the first carrier material can be delivered by soaking and/or immersing the plant-based scaffolding in the first carrier material and the second carrier material can be delivered by injecting the second carrier material into the plant-based scaffolding. In some embodiments, the first carrier material can be delivered by injecting the first carrier material into the plant-based scaffolding and the second carrier material can be delivered by soaking and/or immersing the plant-based scaffolding in the second carrier material.

In some embodiments, the second carrier material can be added to the plant-based scaffolding at least partially concurrently with the first carrier material. In some embodiments, the second carrier material can be added to the plant-based scaffolding before the first carrier material. In some embodiments, the second carrier material can be added to the plant-based scaffolding after the first carrier material. In some embodiments, the second carrier material can have a penetration depth into the plant-based scaffolding less than a penetration depth of the first carrier material. In some embodiments, the second carrier material can include animal cells. In some embodiments, the second carrier material can include skeletal muscle cells, fat cells, connective tissue cells, or skin cells. In some embodiments, the second carrier material can include mammalian cells, fish cells, avian muscle myoblasts, fibroblasts, adipocytes, endothelial cells, epithelial cells, keratinocytes, stem cells, or any combination thereof. In some embodiments, the first carrier material can include a first type of cell and the second carrier material can include a second type of cell, the second type of cell different from the first type of cell. In some embodiments, the first carrier material and the second carrier material can include the same type of cell. In some embodiments, the first carrier material can be mixed with muscle myoblasts and delivered deep within the plant-based scaffolding, while the second carrier material can be mixed with dermal fibroblasts to form a skin concentrated near the external surface of the blended meat product. In some embodiments, the first carrier material can form fat, the second carrier material can form muscle, and the third carrier material can form skin. In some embodiments, the first carrier material that forms the fat can undergo temperature-dependent gelation. In some embodiments, the second carrier material that forms the muscle can undergo a deep delivery with a low concentration ionic gelation. In some embodiments, the third carrier material that forms the skin can undergo high concentration ionic gelation at the surface of the plant and animal cell blended meat product. In some embodiments, the first carrier material can include a first type of cell, the second carrier material can include a second type of cell, and a third type of cell can be injected into an interior region encompassed by the first type of cell and the second type of cell. In some embodiments, the injection of the third type of cell can be done before soaking the first type of cell and the second type of cell. In some embodiments, the injection of the third type of cell can be done after soaking the first type of cell and the second type of cell.

Step 17 is optional and includes incubating the carrier material (s) and the plant-based scaffolding in a controlled environment to produce the meat substitute product. In some embodiments, an osmotic pressure a concentration gradient can be established within the plant-based scaffolding and the carrier material(s) can be drawn inward toward the center of the plant-based scaffolding to reduce or eliminate the concentration gradient during incubation. For example, the plant-based scaffolding can have a higher salt concentration than the carrier material(s), such that liquid from the carrier material(s) migrates toward the center of the plant-based scaffolding during incubation to even out the salt concentration throughout the product. In some embodiments, muscle, fat, and skin cells are segregated in the meat substitute product such that they recapitulate tissue structures found in specific cuts of meat.

The presence of the animal cells in the carrier material(s) and/or the plant-based scaffolding can limit the temperature, pH, and osmotic pressure, at which the incubation can occur. Therefore, the incubation temperature and pH are set to minimize cell death during incubation. In some embodiments, the temperature during incubation can be at least about −20° C., at least about −15° C., at least about −10° C., at least about −5° C., at least about 0° C., at least about 5° C., at least about 10° C., at least about 15° C., at least about 20° C., at least about 21° C., at least about 22° C., at least about 23° C., at least about 24° C., at least about 25° C., at least about 26° C., at least about 27° C., at least about 28° C., at least about 29° C., at least about 30° C., at least about 31° C., at least about 32° C., at least about 33° C., at least about 34° C., at least about 35° C., at least about 36° C., at least about 37° C., at least about 38° C., or at least about 39° C. In some embodiments, the temperature during incubation can be no more than about 40° C., no more than about 39° C., no more than about 38° C., no more than about 37° C., no more than about 36° C., no more than about 35° C., no more than about 34° C., no more than about 33° C., no more than about 32° C., no more than about 31° C., no more than about 30° C., no more than about 29° C., no more than about 28° C., no more than about 27° C., no more than about 26° C., no more than about 25° C., no more than about 24° C., no more than about 23° C., no more than about 22° C., no more than about 21° C., no more than about 20° C., no more than about 15° C., no more than about 10° C., no more than about 5° C., no more than about 0° C., no more than about −5° C., no more than about −10° C., or no more than about −15° C. Combinations of the above-referenced incubation temperatures are also possible (e.g., at least about −20° C. and no more than about 40° C. or at least about 25° C. and no more than about 35° C.), inclusive of all values and ranges therebetween. In some embodiments, the temperature during incubation can be about −20° C., about −15° C., about −10° C., about −5° C., about 0° C., about 5° C., about 10° C., about 15° C., about 20° C., about 21° C., about 22° C., about 23° C., about 24° C., about 25° C., about 26° C., about 27° C., about 28° C., about 29° C., about 30° C., about 31° C., about 32° C., about 33° C., about 34° C., about 35° C., about 36° C., about 37° C., about 38° C., about 39° C., or about 40° C.

In some embodiments, the incubation pH can be at least about 6.5, at least about 6.6, at least about 6.7, at least about 6.8, at least about 6.9, at least about 7, at least about 7.1, at least about 7.2, at least about 7.3, at least about 7.4, at least about 7.5, at least about 7.6, at least about 7.7, at least about 7.8, or at least about 7.9. In some embodiments, the incubation pH can be no more than about 8, no more than about 7.9, no more than about 7.8, no more than about 7.7, no more than about 7.6, no more than about 7.5, no more than about 7.4, no more than about 7.3, no more than about 7.2, no more than about 7.1, no more than about 7, no more than about 6.9, no more than about 6.8, no more than about 6.7, no more than about 6.6, no more than about 6.5, no more than about 6.4, no more than about 6.3, no more than about 6.2, or no more than about 6.1. Combinations of the above-referenced pH values are also possible (e.g., at least about 6.5 and no more than about 8 or at least about 7 and no more than about 7.5), inclusive of all values and ranges therebetween. In some embodiments, the incubation pH can be about 6.5, about 6.6, about 6.7, about 6.8, about 6.9, about 7, about 7.1, about 7.2, about 7.3, about 7.4, about 7.5, about 7.6, about 7.7, about 7.8, about 7.9, or about 8.

In some embodiments, the incubation can be for a time period of at least about 30 minutes, at least about 1 hour, at least about 2 hours, at least about 3 hours, at least about 4 hours, at least about 5 hours, at least about 6 hours, at least about 7 hours, at least about 8 hours, at least about 9 hours, at least about 10 hours, at least about 12 hours, at least about 14 hours, at least about 16 hours, at least about 18 hours, at least about 20 hours, at least about 22 hours, at least about 1 day, at least about 2 days, at least about 3 days, at least about 4 days, at least about 5 days, at least about 10 days, at least about 15 days, at least about 20 days, or at least about 25 days. In some embodiments, the incubation can be for a time period of no more than about 30 days, no more than about 25 days, no more than about 20 days, no more than about 15 days, no more than about 10 days, no more than about 5 days, no more than about 4 days, no more than about 3 days, no more than about 2 days, no more than about 1 day, no more than about 22 hours, no more than about 20 hours, no more than about 18 hours, no more than about 16 hours, no more than about 14 hours, no more than about 12 hours, no more than about 10 hours, no more than about 9 hours, no more than about 8 hours, no more than about 7 hours, no more than about 6 hours, no more than about 5 hours, no more than about 4 hours, no more than about 3 hours, no more than about 2 hours, or no more than about 1 hour.

In some embodiments, the blended meat product can be formed without an incubation period. In some embodiments, osmotic pressure can be the primary mechanism by which the carrier materials are drawn to their desired locations. Scaffold porosity, carrier concentration and viscosity, and infiltration method (e.g., passive diffusion, injection) can be used to control carrier delivery into the plant-based scaffolding. When cells are incorporated into the plant-based scaffolding, the range of osmotic pressures, at which they can survive is narrow.

Combinations of the above-referenced incubation times are also possible (e.g., at least about 30 minutes and no more than about 30 days or at least about 2 hours and no more than about 18 hours), inclusive of all values and ranges therebetween. In some embodiments, the incubation can be for a time period of about 30 minutes, about 1 hour, about 2 hours, about 3 hours, about 4 hours, about 5 hours, about 6 hours, about 7 hours, about 8 hours, about 9 hours, about 10 hours, about 12 hours, about 14 hours, about 16 hours, about 18 hours, about 20 hours, about 22 hours, about 1 day, about 2 days, about 3 days, about 4 days, about 5 days, about 10 days, about 15 days, about 20 days, about 25 days, or about 30 days.

In some embodiments, flavoring can be added to the carrier material(s) and/or the plant-based scaffolding before the incubation period. In some embodiments, flavoring can be added to the carrier material(s) and the plant-based scaffolding during the incubation period. In some embodiments, flavoring can be added to the carrier material(s) and the plant-based scaffolding after the incubation period. In some embodiments, the flavoring can include a flavor enhancer. In some embodiments, the flavoring can include an aroma enhancer. In some embodiments, the flavoring can include one or more spices. In some embodiments, the flavoring can include table salt, black pepper, paprika, oregano, anise, celery seed, cassia, catnip, cardamom, caraway, burnet, brown mustard, borage, black pepper, mustard seeds, cumin, bergamot, basil, bay leaf, asafoetida, anise, angelica, allspice, cayenne pepper, chervil, chicory, chili pepper, cinnamon, cilantro, clove, coriander, costmary, curry, dill, fennel, fenugreek, file, ginger, grains of paradise, holy basil, horehound, horseradish, hyssop, lavender, lemon balm, lemon grass, lemon verbena, licorice, lovage, mace, marjoram, nutmeg, oregano, paprika, parsley, peppermint, poppy seed, rosemary, rue, saffron, sage, savory, sesame, sorrel, star anise, spearmint, tarragon, thyme, turmeric, vanilla, wasabi, or any combination thereof. In some embodiments, a color enhancer can be added before, during, and/or after the incubation period. In some embodiments, animal flavor compounds can be produced via recombinant sources (e.g., recombinant myoglobin) and added to the blended meat product.

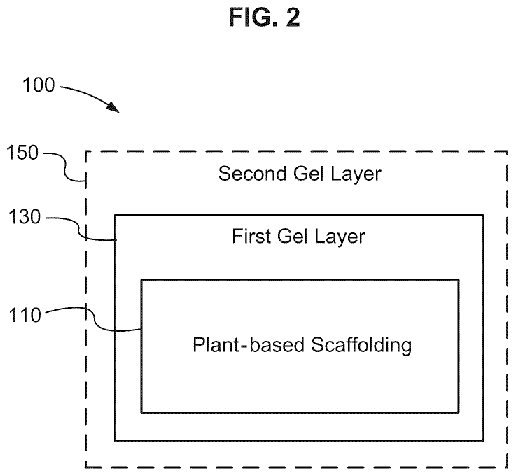

FIG. 2 is a block diagram of a blended meat product 100, according to an embodiment. As shown, the blended meat product 100 includes a plant-based scaffolding 110 and a first gel layer 130. The blended meat product 100 optionally includes a second gel layer 150. In some embodiments, the plant-based scaffolding 110 and the first gel layer 130 can be substantially mixed together, such that they collectively form a single layer of material. The combination of the plant-based scaffolding 110 and the first gel layer 130 are referred to herein as the “interior layers.” In some embodiments, the interior layers can remain separate or partially separated. In some embodiments, the interior layers can form a single layer that is homogeneous or substantially homogeneous.

In some embodiments, the plant-based scaffolding 110 can swell during formation of the blended meat product 100. In some embodiments, the plant-based scaffolding 110 can swell to about 1.5, about 2, about 2.5, about 3, about 3.5, about 4, about 4.5, about 5, about 5.5, about 6, about 6.5, about 7, about 7.5, about 8, about 8.5, about 9, about 9.5, or about 10 times its original size during production of the blended meat product 100, inclusive of all values and ranges therebetween. In some embodiments, the plant-based scaffolding 110 can become substantially softer during production of the blended meat product. In some embodiments, the plant-based scaffolding 110 can become harder after gelation. In some embodiments, the first gel layer 130 can be subsumed or substantially subsumed into the plant-based scaffolding 110 during the production of the blended meat product 100. In some embodiments, the infiltration depth of the first gel layer 130 within the plant-based scaffold 110, and therefore the degree of mixing between the first gel layer 130 and the plant-based scaffolding 110, can be controlled by carrier solution and gelation agent formulations.

In some embodiments, the interior layers can have a first composition and the second gel layer 150 can have a second composition, the second composition different from the first composition. In some embodiments, the interior layers can have a first texture and the second gel layer 150 can have a second texture, the second texture different from the first texture. In some embodiments, the second gel layer 150 can have a skin-like texture. In some embodiments, the second gel layer 150 can have a higher concentration of oils than the interior layers.

In some embodiments, the plant-based scaffolding 110, the first gel layer 130, and/or the second gel layer 150 can include fibers. In some embodiments, the fibers can include animal cells. In some embodiments, the animal cells can include myoblasts, mesenchymal stem cells, fibroblasts, keratinocytes, induced pluripotent stem cells, embryonic stem cells, or any combination thereof. In some embodiments, the animal cells can include differentiated myotubes and/or adipocytes. In some embodiments, the fibers can include cells derived from animal sources, including but not limited to a domestic cow, a pig, a chicken, a quail, and/or a rabbit. In some embodiments, the fibers can include cells derived from aquatic animals, such as crabs or lobsters. In some embodiments, the fibers can include ingredients derived from animal cells.

In some embodiments, the blended meat product 100 can be heart healthy, in accordance with the “heart healthy” definition provided by the Food and Drug Administration (FDA) pursuant to 21 CFR § 101 (Volume 2). In other words, the blended meat product 100 can be certified with the American Heart Association's (AHA) heart-check mark. For example, the blended meat product 100 can include less than 6.5 g of fat, less than 1 g of saturated fat (or less than 15% of its calories can be from saturated fat), less than 0.5 g of trans fat, less than 20 mg of cholesterol, less than 20 mg of sodium, and at least 10% of the daily value of at least one of vitamin A, vitamin C, iron, calcium, protein, or dietary fiber per serving (e.g., 50 g).

In some embodiments, the blended meat product 100 can have a hardness value of at least about 2 N, at least about 2.1 N, at least about 2.2 N, at least about 2.3 N, at least about 2.4 N, at least about 2.5 N, at least about 2.6 N, at least about 2.7 N, at least about 2.8 N, at least about 2.9 N, at least about 3 N, at least about 3.1 N, at least about 3.2 N, at least about 3.3 N, at least about 3.4 N, at least about 3.5 N, at least about 3.6 N, at least about 3.7 N, at least about 3.8 N, or at least about 3.9 N on the textural properties of food scale. In some embodiments, the blended meat product 100 can have a hardness value of no more than about 4 N, no more than about 3.9 N, no more than about 3.8 N, no more than about 3.7 N, no more than about 3.6 N, no more than about 3.5 N, no more than about 3.4 N, no more than about 3.3 N, no more than about 3.2 N, no more than about 3.1 N, no more than about 3 N, no more than about 2.9 N, no more than about 2.8 N, no more than about 2.7 N, no more than about 2.6 N, no more than about 2.5 N, no more than about 2.4 N, no more than about 2.3 N, no more than about 2.2 N, or no more than about 2.1 N. Combinations of the above-referenced hardness values are also possible (e.g., at least about 2 N and no more than about 4 N or at least about 2.3 N and no more than about 3.5 N), inclusive of all values and ranges therebetween. In some embodiments, the blended meat product 100 can have a hardness value of about 2 N, about 2.1 N, about 2.2 N, about 2.3 N, about 2.4 N, about 2.5 N, about 2.6 N, about 2.7 N, about 2.8 N, about 2.9 N, about 3 N, about 3.1 N, about 3.2 N, about 3.3 N, about 3.4 N, about 3.5 N, about 3.6 N, about 3.7 N, about 3.8 N, about 3.9 N, or about 4 N.

In some embodiments, the blended meat product 100 can have a springiness value of at least about 6 N, at least about 6.1 N, at least about 6.2 N, at least about 6.3 N, at least about 6.4 N, at least about 6.5 N, at least about 6.6 N, at least about 6.7 N, at least about 6.8 N, or at least about 6.9 N on the textural properties of food scale. In some embodiments, the blended meat product 100 can have a springiness value of no more than about 7 N, no more than about 6.9 N, no more than about 6.8 N, no more than about 6.7 N, no more than about 6.6 N, no more than about 6.5 N, no more than about 6.4 N, no more than about 6.3 N, no more than about 6.2 N, or no more than about 6.1 N. Combinations of the above-referenced springiness values are also possible (e.g., at least about 6 N and no more than about 7 N or at least about 6.1 N and no more than about 6.9 N), inclusive of all values and ranges therebetween. In some embodiments, the blended meat product 100 can have a springiness value of about 6 N, about 6.1 N, about 6.2 N, about 6.3 N, about 6.4 N, about 6.5 N, about 6.6 N, about 6.7 N, about 6.8 N, about 6.9 N, or about 7 N.

In some embodiments, the blended meat product 100 can have a cohesiveness value of at least about 0.4, at least about 0.41, at least about 0.42, at least about 0.43, at least about 0.44, at least about 0.45, at least about 0.46, at least about 0.47, at least about 0.48, at least about 0.49, at least about 0.5, at least about 0.51, at least about 0.52, at least about 0.53, at least about 0.54, at least about 0.55, at least about 0.56, at least about 0.57, at least about 0.58, or at least about 0.59 on the textural properties food scale. In some embodiments, the fibrous food product can have a cohesiveness value of no more than about 0.6, no more than about 0.59, no more than about 0.58, no more than about 0.57, no more than about 0.56, no more than about 0.55, no more than about 0.54, no more than about 0.53, no more than about 0.52, no more than about 0.51, no more than about 0.5, no more than about 0.49, no more than about 0.48, no more than about 0.47, no more than about 0.46, no more than about 0.45, no more than about 0.44, no more than about 0.43, no more than about 0.42, Or no more than about 0.41. Combinations of the above-referenced cohesiveness values are also possible (e.g., at least about 0.4 and no more than about 0.6 or at least about 0.45 and no more than about 0.55), inclusive of all values and ranges therebetween. In some embodiments, the blended meat product 100 can have a cohesiveness value of about 0.4, about 0.41, about 0.42, about 0.43, about 0.44, about 0.45, about 0.46, about 0.47, about 0.48, about 0.49, about 0.5, about 0.51, about 0.52, about 0.53, about 0.54, about 0.55, about 0.56, about 0.57, about 0.58, about 0.59, or about 0.6.

In some embodiments, the blended meat product 100 can have a gumminess value of at least about 1, at least about 1.1, at least about 1.2, at least about 1.3, at least about 1.4, at least about 1.5, at least about 1.6, at least about 1.7, at least about 1.8, or at least about 1.9 on the textural properties of food scale. In some embodiments, the blended meat product 100 can have a gumminess value of no more than about 2, no more than about 1.9, no more than about 1.8, no more than about 1.7, no more than about 1.6, no more than about 1.5, no more than about 1.4, no more than about 1.3, no more than about 1.2, or no more than about 1.1. Combinations of the above-referenced gumminess values are also possible (e.g., at least about 1 and no more than about 2 or at least about 1.1 and no more than about 1.9), inclusive of all values and ranges therebetween. In some embodiments, the blended meat product 100 can have a gumminess value of about 1, about 1.1, about 1.2, about 1.3, about 1.4, about 1.5, about 1.6, about 1.7, about 1.8, about 1.9, or about 2.

In some embodiments, the blended meat product 100 can have a chewiness value of at least about 0.5, at least about 0.6, at least about 0.7, at least about 0.8, at least about 0.9, at least about 1, at least about 1.1, at least about 1.2, at least about 1.3, or at least about 1.4 on the textural properties of food scale. In some embodiments, the blended meat product 100 can have a chewiness value of no more than about 1.5, no more than about 1.4, no more than about 1.3, no more than about 1.2, no more than about 1.1, no more than about 1, no more than about 0.9, no more than about 0.8, no more than about 0.7, or no more than about 0.6. Combinations of the above-referenced chewiness values are also possible (e.g., at least about 0.5 and no more than about 1.5 or at least about 0.6 and no more than about 1.3), inclusive of all values and ranges therebetween. In some embodiments, the blended meat product 100 can have a chewiness value of about 0.5, about 0.6, about 0.7, about 0.8, about 0.9, about 1, about 1.1, about 1.2, about 1.3, about 1.4, or about 1.5.

In some embodiments, the blended meat product 100 can have a Warner-Bratzler shear strength of at least about 0.25 kg, at least about 0.5 kg, at least about 1 kg, at least about 1.5 kg, at least about 2 kg, at least about 2.5 kg, at least about 3 kg, at least about 3.5 kg, at least about 4 kg, at least about 4.5 kg, at least about 5 kg, or at least about 5.5 kg. In some embodiments, the blended meat product 100 can have a Warner-Bratzler shear strength of no more than about 6 kg, no more than about 5.5 kg, no more than about 5 kg, no more than about 4.5 kg, no more than about 4 kg, no more than about 3.5 kg, no more than about 3 kg, no more than about 2.5 kg, no more than about 2 kg, no more than about 1.5 kg, no more than about 1 kg, or no more than about 0.5 kg. Combinations of the above-referenced Warner-Bratzler shear strengths are also possible (e.g., at least about 0.25 kg and no more than about 6 kg or at least about 0.5 kg and no more than about 5 kg), inclusive of all values and ranges therebetween. In some embodiments, the blended meat product 100 can have a Warner-Bratzler shear strength of about 0.25 kg, about 0.5 kg, about 1 kg, about 1.5 kg, about 2 kg, about 2.5 kg, about 3 kg, about 3.5 kg, about 4 kg, about 4.5 kg, about 5 kg, about 5.5 kg, or about 6 kg.

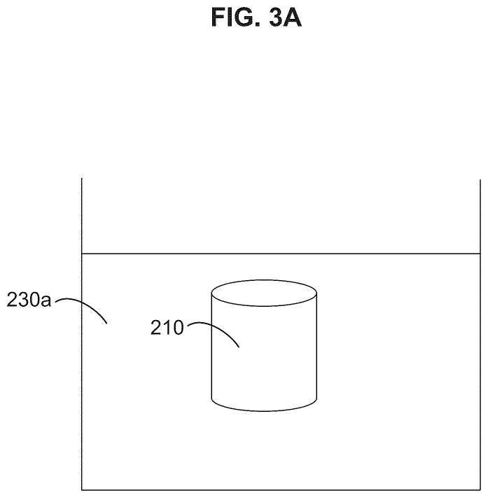

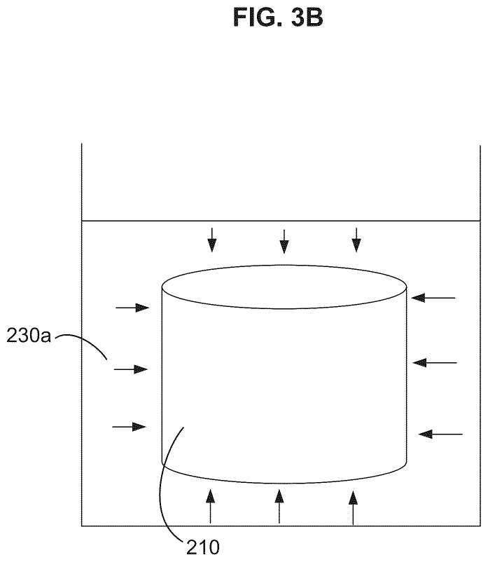

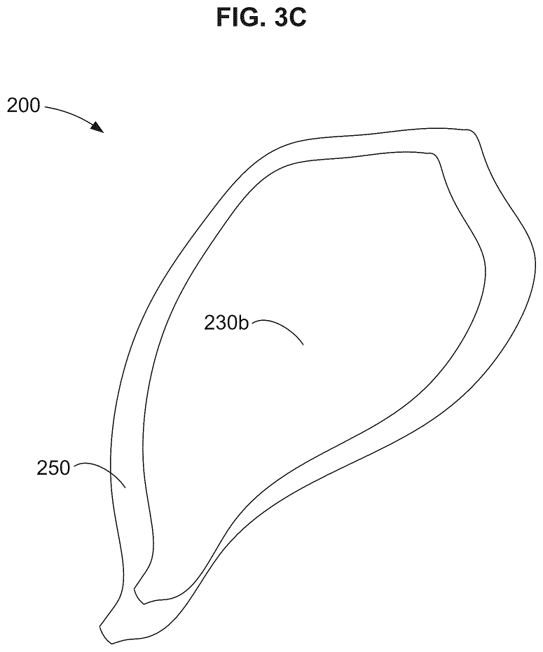

FIGS. 3A-3C are illustrations of a method of producing a blended meat product 200, according to an embodiment. FIG. 3A shows plant-based scaffolding 210 disposed in a vessel and immersed in a first carrier material 230a. A second carrier material (not shown) can be added sequentially after the first carrier material 230a. In some embodiments, the plant-based scaffolding 210, the first carrier material 230a, and the second carrier material can be the same or substantially similar to the plant-based scaffolding 110, the first carrier material and the second carrier material, as described above with reference to FIG. 1. Thus, certain aspects of the plant-based scaffolding 210, the first carrier material 230a, and the second carrier material are not described in greater detail herein.

In some embodiments, the first carrier material 230a and the second carrier material are separate phases. In some embodiments, the first carrier material 230a and the second carrier material can be at least partially mixed together (e.g., in a solution or in an emulsion). As shown, the plant-based scaffolding 210 has a tube shape. In some embodiments, the plant-based scaffolding 210 can have a round or spherical shape. In some embodiments, the plant-based scaffolding 210 can have a substantially linear shape. In some embodiments, the first carrier material 230a can have a deeper penetration depth than the second carrier material. In some embodiments, the second carrier material can have a deeper penetration depth than the first carrier material 230a.

FIG. 3B shows the first carrier material 230a entering the plant-based scaffolding 210 and causing the plant-based scaffolding 210 to expand. In some embodiments, gelation of the first carrier material 230a can occur at least partially simultaneously with the penetration of the first carrier material 230a into the plant-based scaffolding 210. During the penetration of the first carrier material 230a into the plant-based scaffolding 210, the heterogeneity and concentration gradients between the first carrier material 230a and the plant-based scaffolding 210 begin to dissipate. The first carrier material 230a and the plant-based scaffolding 210 become a more homogeneous body.

FIG. 3C shows the blended meat product 200 in a fully formed state. As shown, the blended meat product 200 includes an interior layer 230b and an outer layer 250. In some embodiments, the interior layer 230b can form as a result of the homogenization of the plant-based scaffolding 210 and the first carrier material 230a. In some embodiments, the outer layer 250 can form as a result of gelation and partial penetration of the second carrier material. In some embodiments, the boundary between the interior layer 230b can be somewhat ambiguous, as the change from the outer layer 250 to the interior layer 230b can be gradual. In some embodiments, the outer layer 250 can have properties similar to properties of a skin layer while the interior layer 230b can have properties similar to bulk meat properties. In some embodiments the interior layer 230b and the outer layer 250 can be the same or substantially similar to the interior layer and the second gel layer 150, respectively, as described above with reference to FIG. 2. In some embodiments, the blended meat product 200 can be formed in a mold. In some embodiments, the mold can have a shape of a meat cut. In some embodiments, the mold can have a shape of a chicken breast, a rib, a loin, a round, a flank, a brisket, a shank, a filet, a filet mignon, a chuck, a sirloin, a short loin, a fore shank, a short plate, a porterhouse, a nugget, a tender, a chicken finger, a cutlet, or any other suitable form factor.

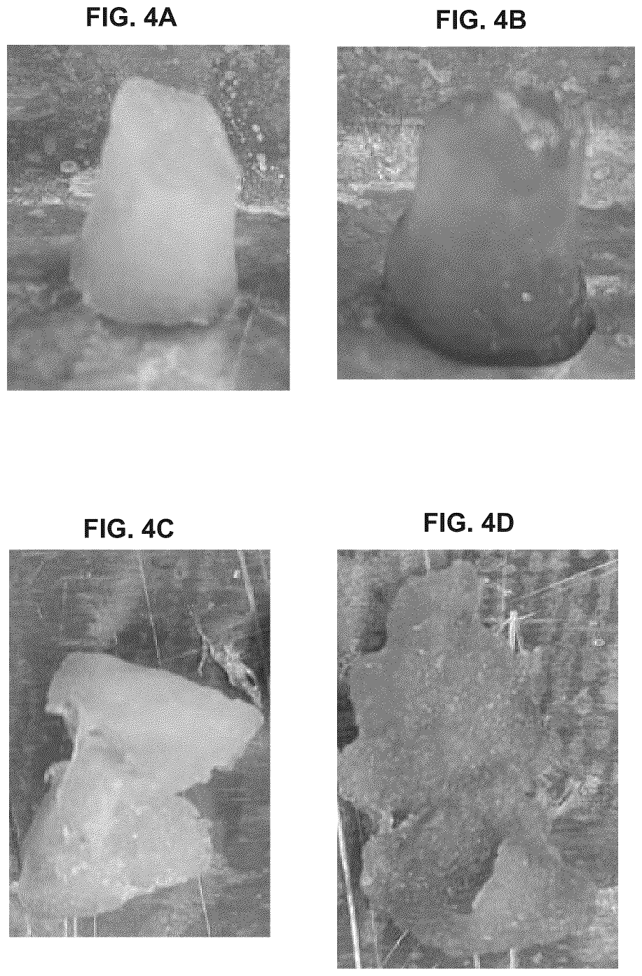

FIGS. 4A-4D show soaking of scaffolds with various levels of carrier liquid diffusion. FIG. 4A shows a scaffold soaked with a carrier liquid that has limited diffusion into the scaffold. FIG. 4B shows a scaffold soaked with a carrier liquid that has complete carrier liquid diffusion. FIG. 4C shows the scaffold from FIG. 4A after being cut open. FIG. 4D shows the scaffold from FIG. 4B after being cut open. As shown, the carrier liquid with the more complete diffusion produces a scaffold with a darker color and a more thorough coloring scheme.

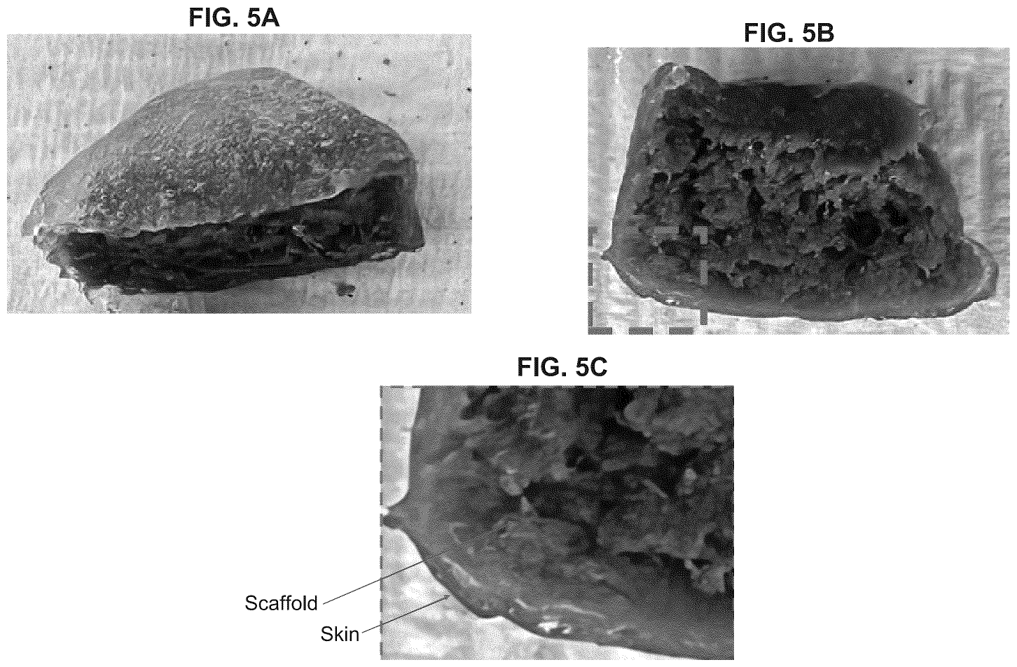

FIGS. 5A-5C show detailed views of a plant-based meat substitute product with a transparent skin covering a scaffold. FIG. 5A shows a top perspective view of the product with a scaffolding visible through the transparent skin. FIG. 5B shows a front view of the product, with the sponge-like texture of the scaffolding visible. FIG. 5C shows a closer view of the front view of the product, with more detail of the scaffold texture and the skin texture visible.

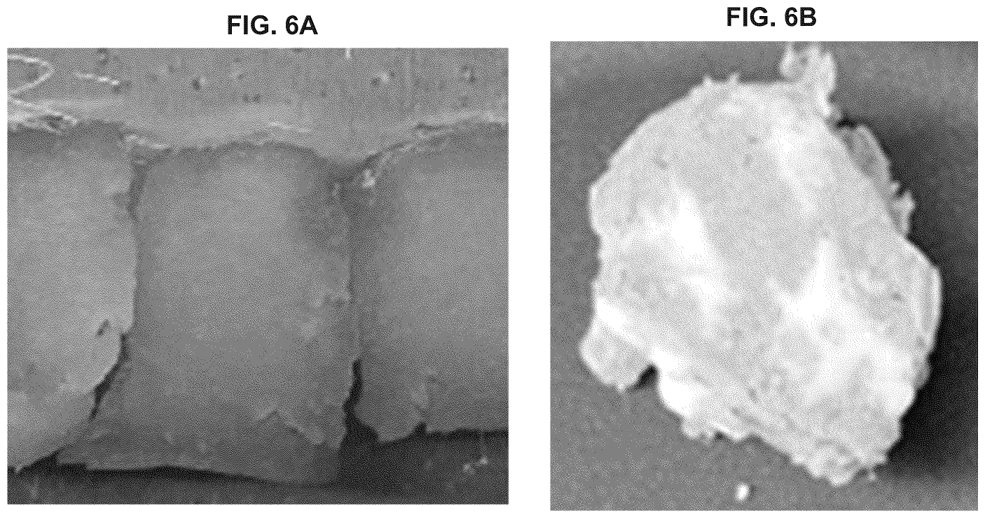

FIGS. 6A-6B show scaffolds penetrated via soaking vs. injection. FIG. 6A shows a scaffold penetrated via soaking. As shown, the redder portion has been penetrated by the carrier liquid thoroughly, while the pink and white portion in the middle has not been penetrated by the carrier liquid as thoroughly. FIG. 6B shows white sections of the scaffold that have been injected with carrier liquid among beige sections. As shown, the composition in the center of the scaffold in FIG. 6B is somewhat heterogeneous, with local “hot-spots” of carrier liquid.

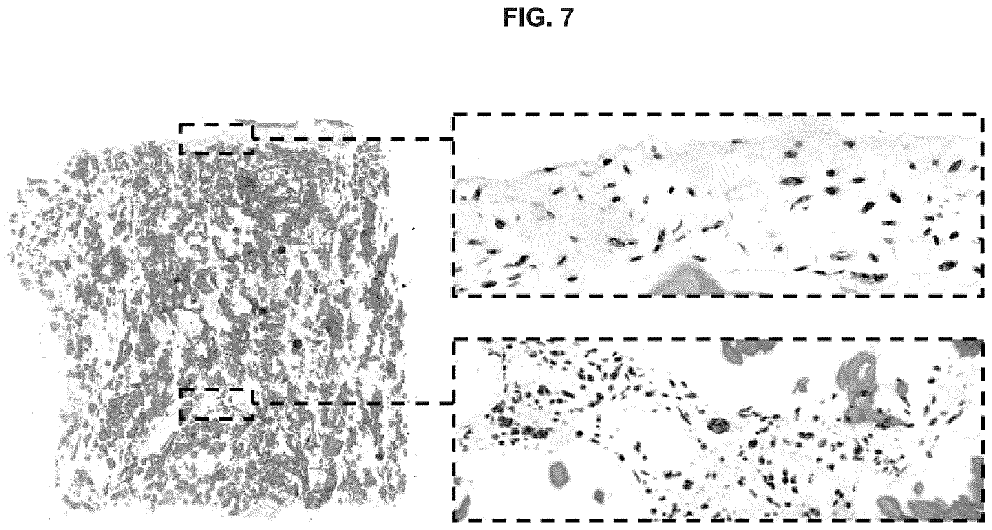

FIG. 7 shows a cross-section of a plant-based meat substitute product that has been histologically stained and imaged at high resolution to reveal cells. The cells are shown as small dark oval-shaped objects visible in the magnified images, which are surrounded by dashed boxes. Magnified views show porcine fibroblasts in the skin region and porcine myoblasts within the product's interior.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may executed serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisional s, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method, comprising:
providing a plant-based scaffolding;
immersing the plant-based scaffolding with a carrier material, the carrier material including animal cells;
gelling the carrier material to the plant-based scaffolding; and
incubating the carrier material and the plant-based scaffolding in a controlled environment to produce a meat substitute product.

2. The method of claim 1, wherein the carrier material includes a carrier liquid.

3. The method of claim 2, wherein immersing the plant-based scaffolding with the carrier material includes injecting the carrier liquid into the plant-based scaffolding.

4. The method of claim 1, wherein the animal cells attach to the plant-based scaffolding via an attachment substrate.

5. The method of claim 1, wherein the animal cells include at least one of skeletal muscle cells, fat cells, connective tissue cells, or skin cells.

6. The method of claim 1, wherein the plant-based scaffolding has a moisture content of about 40 wt % to about 90 wt % before the plant-based scaffolding is immersed with the carrier material.

7. The method of claim 1, wherein the gelling is via a temperature treatment at a temperature between about 60° C. and about 120° C.

8. The method of claim 1, wherein the carrier material is a first carrier material, the method further comprising:
immersing the plant-based scaffold with a second carrier material, the second carrier material having a viscosity different from a viscosity of the first carrier material, the second carrier material having a penetration depth in the plant-based scaffold different from a penetration depth of the first carrier material.

9. The method of claim 8, wherein the second carrier material includes a gelation agent and is configured to form a layer of material separate from the first carrier material.

10. The method of claim 1, wherein the controlled environment is at a temperature of less than about 38° C. and a pH between about 6.5 and about 8.

11. The method of claim 2, wherein the carrier liquid experiences ionic gelation upon adding the gelation agent.

12. The method of claim 2, wherein the carrier liquid experiences gelation upon heating.

13. The method of claim 1, further comprising:
soaking the plant-based scaffolding with a liquid to facilitate gelation.

14. The method of claim 1, wherein the carrier material includes fat substitutes.

15. The method of claim 1, further comprising:
seeding animal cells into the plant-based scaffolding.

16. A meat substitute product, comprising:
a plant-based scaffolding;
a layer of gel surrounding the plant-based scaffolding, the layer of gel including animal cells, at least a portion of the layer of gel penetrating the plant-based scaffolding, the plant-based scaffolding and the layer of gel forming a composition with organoleptic properties the same or substantially similar to organoleptic properties of meat.

17. The meat substitute product of claim 16, further comprising fibers, the fibers including at least one of animal cells or ingredients derived from animal cells.

18. The meat substitute product of claim 16, wherein the layer of gel is a first layer of gel, the meat substitute product further comprising:
a second layer of gel at least partially surrounding the first layer of gel, the second layer of gel having a different composition from the first layer of gel.

19. The meat substitute product of claim 18, wherein at least one of the plant-based scaffolding, the first layer of gel, or the second layer of gel includes fibers.

20. The meat substitute product of claim 16, wherein the animal cells include at least one of skeletal muscle cells, fat cells, connective tissue cells, or skin cells.

21. The meat substitute product of claim 16, wherein the gel enlarges the plant-based scaffolding.
